(19) United States
(12) Patent Application Publication
(10) Pub. No.: US 2021/0320484 A1
(43) Pub. Date: Oct. 14, 2021

(54) Push to Connect Weatherproof Box with Integral Release

(71) Applicant: Hubbell Incorporated, Shelton, CT (US)

(72) Inventors: Victor Beristany, South Bend, IN (US); Krzysztof Wojciech Korcz, Granger, IN (US)

(21) Appl. No.: 17/229,284

(22) Filed: Apr. 13, 2021

Related U.S. Application Data
(60) Provisional application No. 63/009,321, filed on Apr. 13, 2020.

(51) Int. Cl. H02G 3/08; F16L 37/091

(52) U.S. Cl. CPC H02G 3/088; F16L 37/091

(57) ABSTRACT

An electrical box includes an integral conduit receiving port, a weatherproof fitting provided in the conduit receiving port, a conduit gripping member is provided in the integral conduit receiving port, and a conduit release is provided in the conduit receiving port.

### CROSS REFERENCE TO RELATED APPLICATIONS

The present application is based on and claims benefit from co-pending U.S. Provisional Patent Application Ser. No. 63/009,321 filed on Apr. 13, 2020 entitled “Push to Connect Weatherproof Box with Integral Release” the contents of which are incorporated herein in its entirety by reference.

### BACKGROUND

### Field

The present disclosure relates generally to electrical boxes, and more particularly to push-to-connect weatherproof electrical boxes with a built-in release structure.

### Description of the Related Art

Commercial and residential buildings often use common electrical components such as electrical outlets and ground fault circuit interrupter (GFCI) outlets for connecting to a 120v, 240v or similar wiring in a building. These components are often enclosed in electrical boxes mounted in walls, floors and ceilings. In certain applications including, for example, outdoor applications, it is also desirable to use weatherproof electrical boxes. It is often desirable to provide weatherproof electrical boxes capable of receiving electrical wire conduit such as electrical metallic tubing (EMT), Rigid or polyvinyl chloride (PVC) conduit.

Conduit fittings are generally separate devices that are mounted in a standard casting knockout hole in an electrical box. For example, a standard electrical box may have a simple knockout or plug in an opening that may be removed. A traditional conduit fitting would be a separate device that has a mechanism such as a threaded nut and washer for securing the conduit fitting in the electrical box. Installing a separate conduit fitting in an electrical box such as by using a nut and washer increase labor costs and requires additional logistics for additional parts and tools for installation.

### SUMMARY

The present disclosure relates to an electrical box including an integral conduit receiving port and a conduit retention assembly secured within the conduit receiving port. The present disclosure also relates to conduit retention assemblies used to secure conduits to electrical boxes and to release conduits from the electrical boxes.

In one exemplary embodiment, the electrical box is a weatherproof electrical box that includes an integral conduit receiving port, a conduit retention assembly secured within the conduit receiving port and one or more sealing members within the conduit receiving port that contact conduits inserted into the conduit receiving port to create a sealed fit to limit and possible prevent moisture from entering the electrical box.

In another exemplary embodiment, an electrical box includes at least one conduit receiving port and at least one conduit retention assembly. The conduit receiving port has a retention assembly opening. The conduit retention assembly is positioned in the retention assembly opening and includes one or more conduit gripping members, a pressure ring positioned adjacent the conduit gripping member, and a conduit release member operatively coupled to the pressure ring and movable relative to the pressure ring.

In another exemplary embodiment, an electrical box includes at least one conduit receiving port and at least one conduit retention assembly. The electrical box may also include a removable cap that is operatively coupled to the at least one conduit retention assembly. The at least one conduit receiving port has an inner surface and a retention assembly opening, and the at least one conduit retention assembly is positioned within the retention assembly opening. The at least one conduit retention assembly includes one or more conduit gripping members, a pressure ring and a conduit release member. In some embodiments there may be a single gripping member that may include a ring having a hollow central portion and a plurality of teeth of varying lengths, e.g., between about 0.050 inches and about 0.375 inches, extending from the ring toward the hollow central portion. The plurality of teeth preferably extend at an angle, e.g., in a range of about 10 degrees and about 70 degrees, relative to the ring. In one exemplary embodiment, the plurality of teeth of varying lengths include a plurality of teeth having a first length and a plurality of teeth having a second length, where the first length may be shorter than the second length. In this configuration, the plurality of first length teeth and the plurality of second length teeth are arrange around the ring in an alternating pattern. In another exemplary embodiment, the plurality of teeth of varying lengths include a plurality of teeth having a first length and a plurality of teeth having a second length, where the first length may be shorter than the second length. In this configuration, the plurality of first length teeth are arrange around the ring in at least one first length group, and the plurality of second length teeth are arrange around the ring in at least one second length group. In other embodiments there may be multiple gripping members where each gripping member may include a ring having a hollow central portion and a plurality of teeth of a certain length extending from the ring toward the hollow central portion. As a non-limiting example, a first gripping member may have a ring having a hollow central portion and a plurality of teeth of a first length, e.g., between about 0.100 inches and about 0.375 inches, and a second gripping member may have a ring having a hollow central portion and a plurality of teeth of a second length, e.g., between about 0.050 inches and about 0.250 inches. The pressure ring is positioned adjacent the conduit gripping member. The pressure ring may include a circular body having at least one rib extending along an outer surface of the body. The at least one rib is preferably configured and dimensioned to engage a notch in the inner surface of the at least one conduit receiving port. The pressure ring may also include at least one rail extending from an inner surface of the pressure ring toward a center opening of the pressure ring. The conduit release member is operatively coupled to the pressure ring and is movable, e.g., rotatable, relative to the pressure ring. In this configuration, the at least one rail is positioned within a track in the conduit release member so that the at least one rail can slide or ride along the track in the conduit release member when the conduit release member is moved, e.g., rotated, relative to the pressure ring.

In another exemplary embodiment, an electrical box includes at least one conduit receiving port and at least one conduit retention assembly. The electrical box may also include a removable cap that is operatively coupled to the conduit release member. In this exemplary embodiment, the at least one conduit receiving port has an inner surface and a retention assembly opening, and the at least one conduit retention assembly is secured within the retention assembly opening. The at least one conduit retention assembly includes one or more conduit gripping members, a pressure ring and a conduit release member. In some embodiments there may be a single conduit gripping member that includes a ring having a hollow central portion and a plurality of teeth of varying lengths, e.g., between about 0.050 inches and about 0.375 inches, extending from the ring toward the hollow central portion. Preferably, the plurality of teeth extend at an angle, e.g., in a range of about 10 degrees and about 70 degrees, relative to the ring. In one exemplary embodiment, the plurality of teeth of varying lengths include a plurality of teeth having a first length and a plurality of teeth having a second length, where the first length may be shorter than the second length. In this configuration, the plurality of first length teeth and the plurality of second length teeth are arrange around the ring in an alternating pattern. In another embodiment, the plurality of teeth of varying lengths include a plurality of teeth having a first length and a plurality of teeth having a second length, where the first length is shorter than the second length. In this configuration, the plurality of first length teeth are arrange around the ring in at least one first length group, and the plurality of second length teeth are arrange around the ring in at least one second length group. In other embodiments there may be multiple gripping members where each gripping member may include a ring having a hollow central portion and a plurality of teeth of a certain length extending from the ring toward the hollow central portion. As a non-limiting example, a first gripping member may have a ring having a hollow central portion and a plurality of teeth of a first length, e.g., between about 0.100 inches and about 0.375 inches, and a second gripping member may have a ring having a hollow central portion and a plurality of teeth of a second length, e.g., between about 0.050 inches and about 0.250 inches.

The pressure ring is preferably positioned adjacent the conduit gripping member. The pressure ring may include a circular body having at least one rib extending along an outer surface of the body that is configured to engage a notch in the inner surface of the at least one conduit receiving port. The pressure ring may include at least one rail extending from an inner surface of the pressure ring toward a center opening of the pressure ring. The conduit release member is operatively coupled to the pressure ring and movable, e.g., rotatable, relative to the pressure ring. In this configuration, the at least one rail is positioned within a track in the conduit release member so that the at least one rail can slide along the track in the conduit release member when the conduit release member is moved, e.g., rotated, relative to the pressure ring.

In one exemplary embodiment, a conduit retention assembly according to the present disclosure includes one or more conduit gripping members, a pressure ring positioned adjacent the conduit gripping member, and a conduit release member operatively coupled to the pressure ring and movable relative to the pressure ring.

In another exemplary embodiment, a conduit retention assembly includes a conduit gripping member, a pressure ring and a conduit release member. In some embodiments there may be a single conduit gripping member that includes a ring having a hollow central portion and a plurality of teeth of varying length, e.g., between about 0.050 inches and about 0.375 inches, extending from the ring toward the hollow central portion such that each of the plurality of teeth are at an angle, e.g., in a range of about 10 degrees and about 70 degrees, relative to the ring. In one exemplary embodiment, the plurality of teeth of varying lengths include a plurality of teeth having a first length and a plurality of teeth having a second length. Preferably, the first length is shorter than the second length. In this configuration, the plurality of first length teeth and the plurality of second length teeth are arrange around the ring in an alternating pattern. In another exemplary embodiment, the plurality of teeth of varying lengths include a plurality of teeth having a first length and a plurality of teeth having a second length. Preferably, the first length is shorter than the second length. In this configuration, the plurality of first length teeth are arrange around the ring in at least one first length group, and wherein the plurality of second length teeth are arrange around the ring in at least one second length group. In other embodiments there may be multiple gripping members where each gripping member may include a ring having a hollow central portion and a plurality of teeth of a certain length extending from the ring toward the hollow central portion. As a non-limiting example, a first gripping member may have a ring having a hollow central portion and a plurality of teeth of a first length, e.g., between about 0.100 inches and about 0.375 inches, and a second gripping member may have a ring having a hollow central portion and a plurality of teeth of a second length, e.g., between about 0.050 inches and about 0.250 inches. The pressure ring is preferably positioned adjacent the conduit gripping member. The pressure ring may include at least one rib extending along an outer surface of the pressure ring configured to engage a notch in a conduit receiving port of an electrical box. The pressure ring may also include at least one rail extending from an inner surface of the pressure ring toward a center opening of the pressure ring. The conduit release member is operatively coupled to the pressure ring and is movable, e.g., rotatable, relative to the pressure ring. In this configuration, the at least one rail is positioned within a track in the conduit release member so that the at least one rail can slide along the track in the conduit release member when the conduit release member is moved, e.g., rotated, relative to the pressure ring.

### BRIEF DESCRIPTION OF THE DRAWINGS

The accompanying drawings illustrate presently preferred embodiments of the present disclosure, and together with the general description given above and the detailed description given below, serve to explain principles of the disclosure. As shown throughout the drawings, like reference numerals designate like or corresponding parts.

FIG. 1 is a perspective view of an exemplary embodiment of an electrical box according to the present disclosure, illustrating multiple electrical conduits each secured within a conduit receiving port using a retention assembly positioned within the conduit receiving ports;

FIG. 2 is a perspective view of another exemplary embodiment of an electrical box according to the present disclosure, illustrating a top conduit receiving port having a retention assembly positioned therein and a removable cap secured to the retention assembly, and a bottom conduit receiving port having a retention assembly positioned therein;

FIG. 3 is a side view of the electrical box of FIG. 2, illustrating a top conduit receiving port and a bottom conduit receiving port;

FIG. 4 is a cross-sectional view of the electrical box of FIG. 3 taken along the lines 4-4;

FIG. 5 is an exploded perspective view of the electrical box of FIG. 2, illustrating components of a retention assembly secured within the top conduit receiving port;

FIG. 6 is a side perspective view of an exemplary embodiment of the retention assembly according to the present disclosure;

FIG. 7 is an exploded perspective view of the retention assembly of FIG. 6;

FIG. 8 is a side perspective view of another exemplary embodiment of a retention assembly according to the present disclosure;

FIG. 9 is an exploded perspective view of the retention assembly of FIG. 8;

FIG. 10 is a partial cutaway view of the electrical box of FIG. 2, illustrating a conduit being gripped by an exemplary embodiment of a conduit gripping member of the conduit retention assembly of FIG. 6;

FIG. 11 is an enlarged perspective view of a portion of the electrical box of FIG. 10, illustrating a conduit being gripped by the conduit gripping member;

FIG. 12 is a partial cutaway view of the electrical box of FIG. 2 similar to FIG. 10, illustrating a release member of the conduit retention assembly being rotated so that release member pushes teeth of the conduit gripping member out of contact with the conduit;

FIG. 13 is an enlarged perspective view of a portion of the electrical box of FIG. 12, illustrating the release member of the conduit retention assembly pushing teeth of the conduit gripping member out of contact with the conduit;

FIG. 14 is an enlarged perspective view of a conduit within the retention assembly of FIG. 13, illustrating the release member of the conduit retention assembly pushing teeth of the conduit gripping member out of contact with the conduit;

FIG. 15 is a top plan view of a smaller outer diameter conduit within a conduit receiving port of the electrical box of FIG. 2, illustrating larger teeth of an exemplary embodiment of a conduit gripping member gripping the conduit;

FIG. 16 is a top plan view of a larger outer diameter conduit within a conduit receiving port of the electrical box of FIG. 2, illustrating larger and smaller teeth of the conduit gripping member gripping the conduit;

FIG. 17 is a top plan view of another exemplary embodiment of a conduit gripping member according to the present disclosure;

FIG. 18 is a side perspective view or another exemplary embodiment of a conduit gripping member according to the present disclosure;

FIG. 19 is a top plan view of the conduit gripping member of FIG. 17, illustrating larger teeth of the conduit gripping member gripping an EMT type conduit of a certain size;

FIG. 20 is a top plan view of the conduit gripping member of FIG. 17, illustrating larger teeth and smaller teeth of the conduit gripping member gripping a Rigid type conduit of the same certain size;

FIG. 21 is a top plan view of the conduit gripping member of FIG. 17, illustrating larger teeth of the conduit gripping member gripping an PVC type conduit of the same certain size;

FIG. 22 is an exploded perspective view of another exemplary embodiment of a retention assembly according to the present disclosure;

FIG. 23 is an enlarged perspective view of a conduit within the retention assembly of FIG. 22, illustrating the release member of the conduit retention assembly pushing teeth of a first conduit gripping member out of contact with the conduit; and

FIG. 24 is a portion of the retention assembly of FIG. 22 illustrating the release member of the conduit retention assembly pushing teeth of a second conduit gripping member out of contact with the conduit.

### DETAILED DESCRIPTION

The present disclosure describes exemplary embodiments of electrical boxes, e.g., weatherproof electrical boxes, having one or more conduit receiving ports that include integral or built-in push-fit type conduit retention assemblies that can accept multiple electrical conduit sizes and/or accept multiple conduit types of the same size, and that include an integral or built-in conduit release member. In some embodiments, the push-fit type retention assemblies may be configured to receive different diameter conduits, such as ½ inch conduits and ¾ inch conduits. In other embodiments, the push-fit type retention assemblies may be configured to receive different types of conduits, such as PVC conduits, EMT conduits and Rigid conduits of the same size, e.g., ½ inch or ¾ inch PVC conduits, EMT conduits and Rigid conduits. The electrical boxes are capable of accepting electrical wiring devices such as switches, receptacles, circuit interrupting receptacles, light fixtures and other electrical devices, and the push-fit conduit retention assemblies reduce installation labor when compared to the installation of electrical boxes with traditional connector fittings. The electrical boxes shown herein are weatherproof electrical boxes. The electrical boxes may also be referred to herein as the “boxes” in the plural and the “box” in the singular. The push-fit type conduit retention assemblies may also be referred to herein as the “retention assemblies” in the plural and the “retention assembly” in the singular. The electrical conduit may also be referred to herein as the “conduits” in the plural and the “conduit” in the singular.

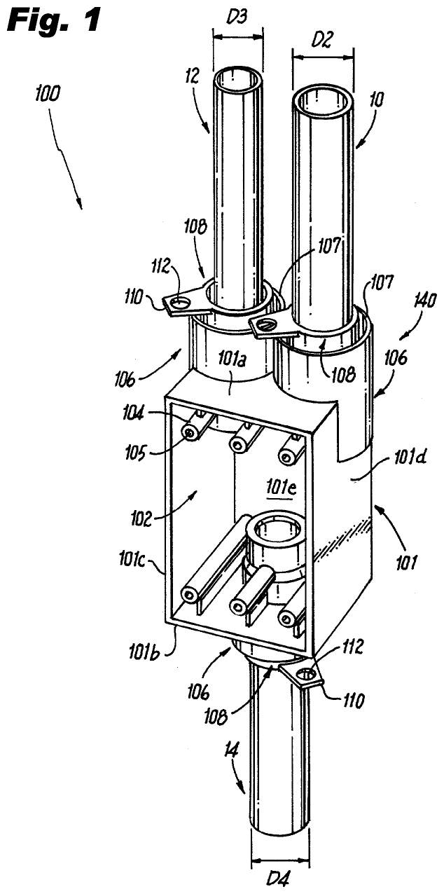

Referring now to FIG. 1, an exemplary embodiment of a box 100 is shown. In this exemplary embodiment, the box 100 includes a housing 101, one or more supports 104 and one or more hubs or conduit receiving ports 106. The housing 101 has a top wall 101a, a bottom wall 101b, a first side wall 101c, a second side wall 101d and a rear wall 101e that define a device opening 102. The supports 104 may be integrally or monolithically formed into the housing 101 within the device opening 102 of box 100 at suitable positions. In other embodiments, the supports 104 may be secured to the housing 101 within the device opening 102. In the embodiment shown, each support 104 includes an opening 105 that is capable of receiving a fastener (not shown), for example a set screw, used to secure an electrical device and/or faceplate to the housing 101. The one or more conduit receiving ports 106 are preferably integral with or monolithically formed into the housing 101. In other embodiments, the one or more conduit receiving ports 106 are secured to the housing 101 by, for example, welds or threaded connections.

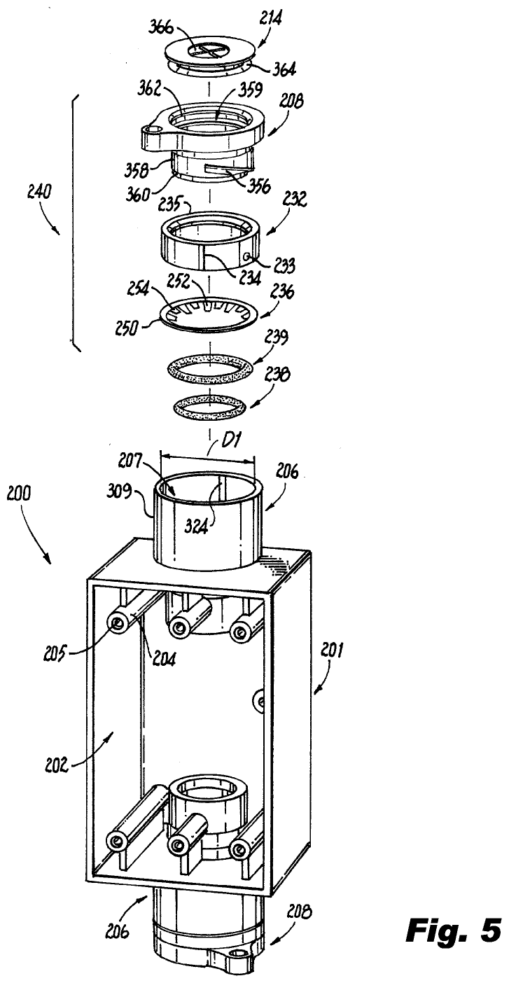

In the exemplary embodiment depicted in FIG. 1, the box 100 includes two conduit receiving ports 106 on or extending from the top wall 101a of the housing 101, and a single conduit receiving port 106 is located on or extending from the bottom wall 101b of the housing 101. The present disclosure contemplates any other configuration of conduit receiving ports 106 that may be provided on the housing 101 allowing an electrician or other installer to select a box 100 suitable for a particular application. Each conduit receiving port 106 includes a retention assembly opening 107 that is in communication with the device opening 102. As will be described in more detail below, a diameter “D1,” seen in FIG. 5, of the inner surface of each conduit receiving port 106 is configured, dimensioned and shaped to receive a retention assembly 140. The retention assembly 140 is secured within the retention assembly opening 107 in the conduit receiving port 106 using, for example, a friction fit, adhesives, mechanical fasteners and/or welds. The retention assembly 140 may be capable of receiving various outer diameter conduits 10, 12 and/or 14, shown in FIG. 1. As a non-limiting example, the conduit 10 may be a ¾ inch conduit with an outer diameter “D2” of about 0.875 inches, the conduit 12 may be a ½ inch conduit with an outer diameter “D3” of about 1.125 inches, and the conduit 14 may be a 1 inch conduit with an outer diameter “D4” of about 1.375 inches. In other embodiments, the retention assembly 140 may be capable of receiving different conduit types of the same side. As non-limiting examples, the retention assembly 140 may be capable of receiving the PVC type conduits of the same size, e.g., ½ inch or ¾ inch PVC conduit, or the retention assembly 140 may be capable of receiving EMT type conduits of the same size, e.g., ½ inch or ¾ inch EMT conduit, or retention assembly 140 may be capable of receiving Rigid type conduits of the same size, e.g., ½ inch or ¾ inch Rigid conduit. The retention assembly 140 is also capable of locking the conduit, e.g., conduit 10, 12 or 14, within the conduit receiving port 106. The retention assembly 140 includes a release member 108 having a lever arm 110 extending therefrom and used to rotate the release member 108. The lever arm 110 may include an orifice 112 for insertion of a tool, e.g., a screwdriver, to help rotate the release member 108.

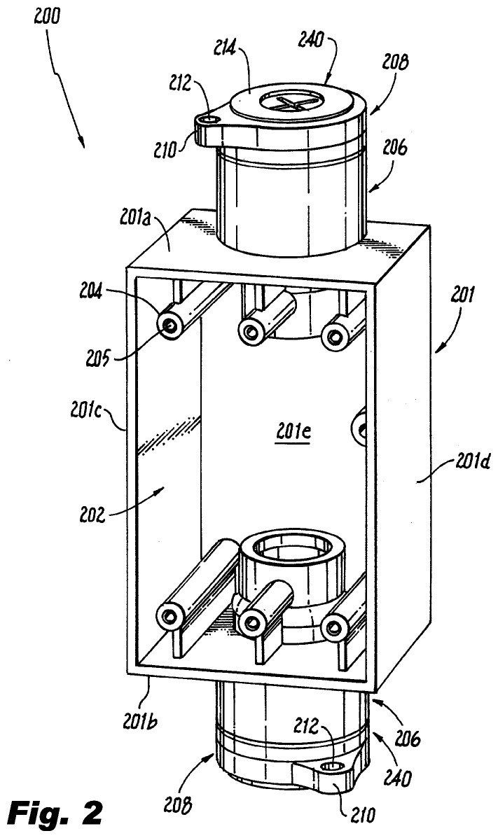

Referring to FIGS. 2-4, another exemplary embodiment of the box according to the present disclosure is shown. In this exemplary embodiment, the box 200 includes a housing 201, one or more supports 204 and one or more hubs or conduit receiving ports 206. The housing 201 has a top wall 201a, a bottom wall 201b, a first side wall 201c, a second side wall 201d and a rear wall 201e that define a device opening 202. The one or more supports 204 are integrally formed within the device opening 202 of the box 200 at suitable positions. In the embodiment shown, each supports 204 includes an opening 205 that is capable of receiving a fastener (not shown), for example a set screw, used to secure an electrical device and/or faceplate (not shown) to the housing 201. The one or more conduit receiving ports 206 are preferably integral with or monolithically formed into the housing 201. In the exemplary embodiment depicted in FIG. 2, the box 100 includes a single conduit receiving port 206 on or extending from the top wall 201a of the housing 201, and a single conduit receiving port 206 on or extending from the bottom wall 201b of the housing 201. Each conduit receiving port 206 includes a retention assembly opening 207 that is in communication with the device opening 202. As will be described in more detail below, a diameter “D1,” seen in FIG. 5, of the inner surface of each retention assembly opening 207 of each conduit receiving port 206 is configured, dimensioned and shaped to receive a retention assembly 240, seen in FIG. 5. The retention assembly 240 is secured within the retention assembly opening 207 in the conduit receiving port 206 using, for example, a friction fit, adhesives, mechanical fasteners and/or welds. The retention assembly 240 is substantially the same as the retention assembly 140 described above.

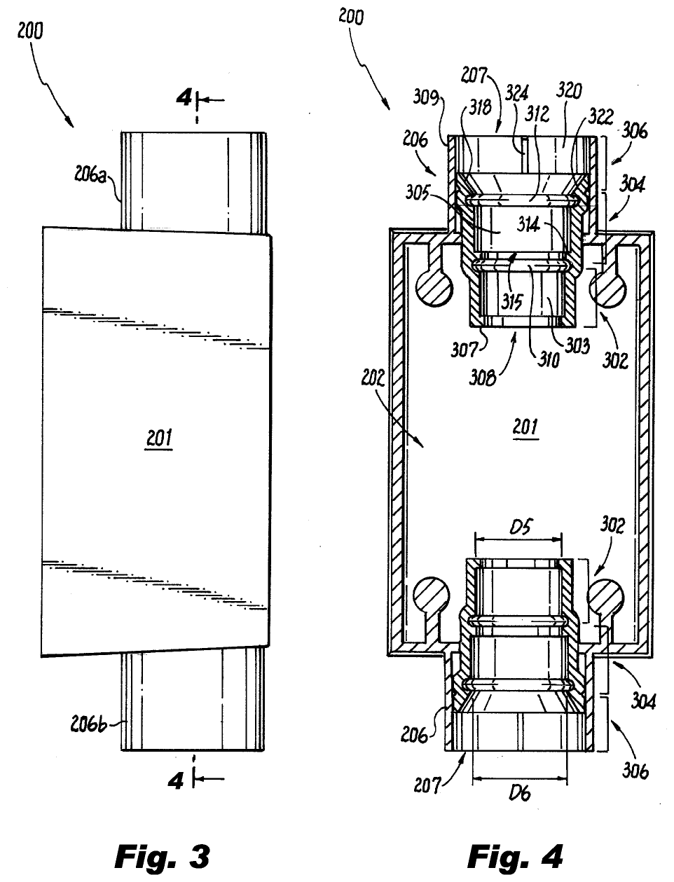

Referring to FIGS. 3 and 4, each conduit receiving port 206 includes a lower portion 302, a middle portion 304 and an upper portion 306. The lower portion 302 includes a chamber 303, a seal member groove 310 and a lower lip 307 surrounding an opening 308. The chamber 303 is preferably circular in cross-section and is configured and dimensioned to receive a conduit, e.g., conduit 10, 12 or 14, having a smaller outer diameter “D5” in the range of about 0.688 inches and about 1.00 inches. The seal member groove 310 is positioned in an inner wall of the chamber 303. The seal member groove 310 is configured and dimensioned to receive a seal member 238, seen in FIG. 5. The lip 307, seen in FIG. 4, is provided to act as a stop so that when a conduit 10,12 or 14, or conduit 54, 56 and 58 is inserted into the lower portion 302 of the conduit receiving port 206 an end of the conduit 10, 12 or 14, or conduit 54, 56 and 58 can rest on the lower lip 307 thus preventing the conduit from entering the device opening 202. The opening 308 is provided in the lower portion 302 to allow electrical wires being held by the conduit 10, 12, or 14 to pass into the device opening 202 of the box 200.

Continuing to refer to FIGS. 3 and 4, the middle portion 304 of the conduit receiving port 206 includes a chamber 305, a seal member groove 312 and a lip 314 surrounding an opening 315. The chamber 305 is preferably circular in cross-section and is configured and dimensioned to receive a conduit, e.g., conduit 10, 12 or 14, or conduit 54, 56 and 58, having a larger outer diameter “D6” in, for example, the range of about 0.900 inches and about 1.100 inches. Thus, in this exemplary embodiment, the larger outer diameter “D6” is larger than the smaller outer diameter “D5” which allows conduits with various larger outer diameters to be inserted into and secured within the conduit receiving port 206 using the retention assembly 240, as seen in FIG. 5. The seal member groove 312 is positioned in an inner wall of the chamber 305. The seal member groove 312 is configured and dimensioned to receive a seal member 239, seen in FIG. 5. The lip 314 is provided to act as a stop so that when a conduit with a larger outer diameter is inserted into the middle portion 304 of the conduit receiving port 206 an end of the conduit can rest on the middle lip 314.

The seal members 238 and 239, seen in FIG. 5, in the exemplary embodiment shown are circular members having a center opening therethrough. A non-limiting example of a seal member 238 and/or 239 that can be inserted into the respective seal member groove, 310 or 312 is an O-ring. The seal members 238 and 239 are formed from any suitable material that is sufficiently flexible, structurally and environmentally durable and resilient. Non-limiting examples of a suitable material for the seal members 238 and 239 include silicone, rubber and latex. The seal members 238 and 239 have different inner diameters such that when the seal member 238 and/or 239 is in contact with a proper sized conduit 10, 12, 14 inserted into the chamber 303 or 305, a sealed fit is formed between the seal member 238 or 239 and the outer surface of the conduit minimizing and possibly preventing moisture from passing into the device opening 202 of the box 200.

Continuing to refer to FIGS. 3 and 4, the upper portion 306 includes a circular wall 309 defining the retention assembly opening 207. The retention assembly opening 207 includes an assembly receiving area 320, a tapered surface area 322 and a lip 318 between the assembly receiving area 320 and the tapered surface area 322. The lip 318 is provided as a rest for the retention assembly 240. The assembly receiving area 320 has an inner diameter configured and dimensioned to receive the retention assembly 240, seen in FIG. 5. Within an inner surface of the wall 309 of the assembly receiving area 320 are one or more vertical notches 324. The inwardly tapered surface area 322 provides sufficient area into which a conduit gripping member 236 of the retention assembly 240, seen in FIG. 5, can extend and/or flex when a conduit 10, 12, or 14 is inserted into the retention assembly 240 or when the release member 208, seen in FIG. 5, is activated to release the grip of the conduit gripping member 236 on the conduit as described herein. The retention assembly opening 207 is in communication with the opening 315 through chamber 305 and the opening 308 through chamber 303 so that electrical conductors held within the conduit 10, 12, or 14 can pass into the device opening 202.

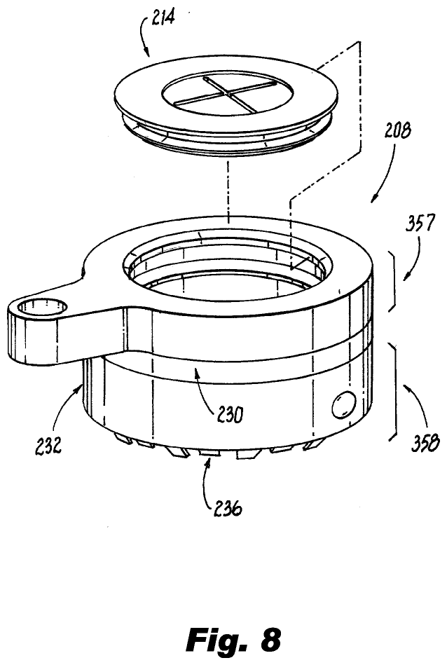

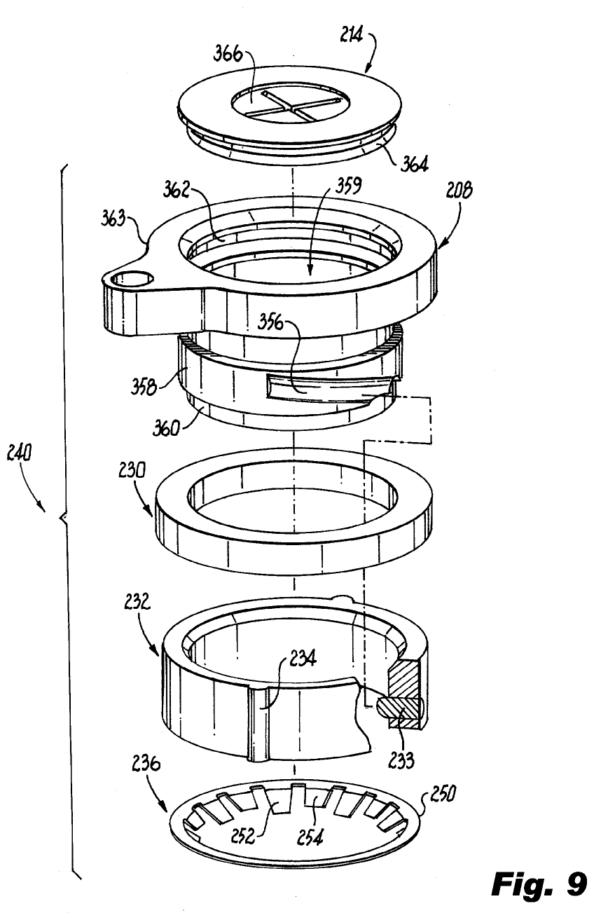

Referring to FIG. 5-9, exemplary embodiments of the retention assembly 240 according to the present disclosure are shown. The components of the retention assembly 240 are shown removed from their particular spaces in the retention assembly opening 207 of the conduit receiving port 206. In one exemplary embodiment, the retention assembly 240 includes a release member 208, a pressure ring 232 and one or more conduit gripping members 236, seen in FIGS. 5-7. In another exemplary embodiment, the retention assembly 240 includes the release member 208, the pressure ring 232, the one or more conduit gripping members 236 and a removable cap 214, seen in FIGS. 5-7. In another exemplary embodiment, the retention assembly 240 includes the release member 208, a second sealing member 230, the pressure ring 232 and the one or more conduit gripping members 236, seen in FIGS. 8 and 9. In another exemplary embodiment, the retention assembly 240 may include the release member 208, the second sealing member 230, the pressure ring 232, the one or more conduit gripping members 236 and a removable cap 214, seen in FIGS. 8 and 9.

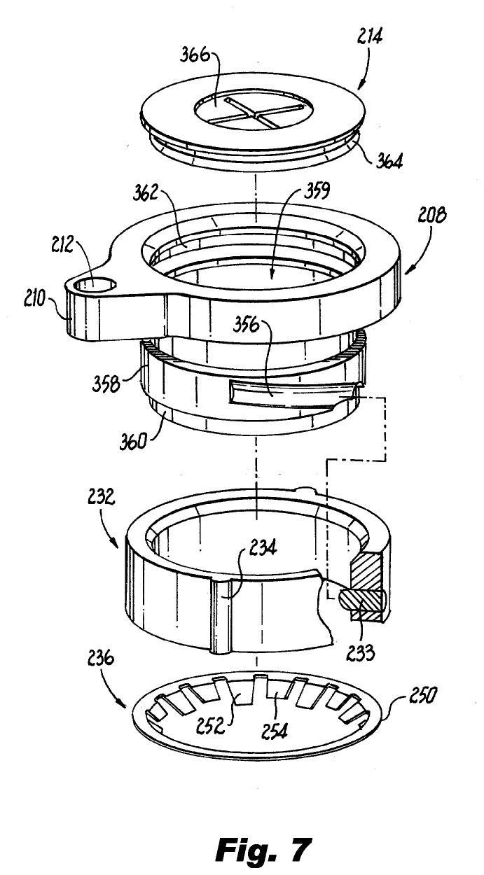

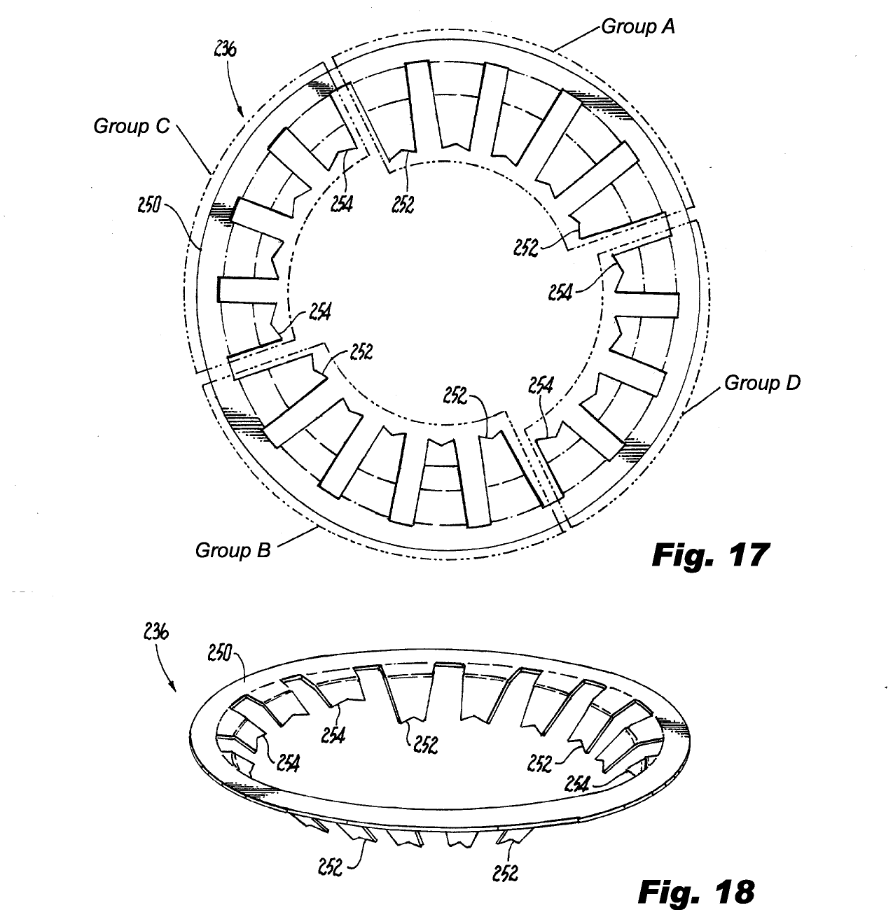

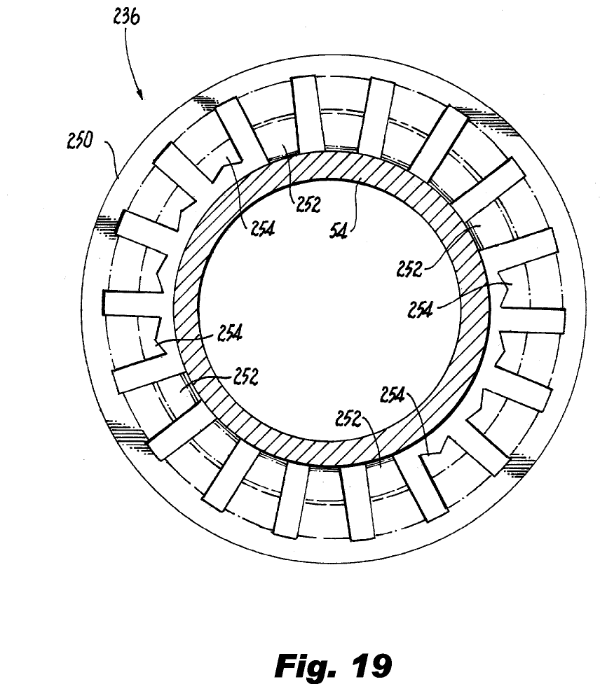

In the exemplary embodiment of FIGS. 5 and 7, each of the one or more conduit gripping members 236 includes a circular ring member 250 with a hollow central portion. The hollow central portion is configured and dimensioned to receive the desired smaller and larger diameter conduits of different sizes 10, 12 or 14, seen in FIG. 1, or the smaller and larger diameter of the same size conduit made of different materials 54, 56 and 58, seen in FIGS. 19-21. Each conduit gripping member 236 is formed from a rigid material, such as steel. Preferably, each conduit gripping member 236 is formed from spring steel such as, for example, 1050 annealed spring steel that may be zinc plated. In the exemplary embodiment shown in FIGS. 5-7, the conduit gripping member 236 is a spring-like structure that includes one or more teeth or prongs 252 and 254 of varying lengths extending from the circular ring member 250 toward the hollow central portion and angled relative to the circular ring. The one or more teeth or prongs 252 and 254 are positioned around the circular ring member 250 in an alternating arrangement such that a long tooth 252 is adjacent two short teeth 254. In another exemplary embodiment shown in FIGS. 17 and 18, the conduit gripping member 236 is also a spring-like structure that includes one or more teeth or prongs 252 and 254 of varying lengths extending from the circular ring member 250 toward the hollow central portion of the circular ring and angled relative to the circular ring member 250. In this exemplary embodiment, the one or more teeth or prongs 252 and 254 are positioned around the circular ring member 250 in groupings of long teeth 252 and groupings of short teeth 254. The groupings of teeth 252 or 254 include two or more teeth in the grouping. For example, in the embodiment of FIGS. 17 and 18, there are two groups of long teeth 252 and two groups of short teeth 254 and the groups are alternately positioned around the circular ring member 250. Each group of long teeth 252 includes the same number of teeth but may include a different number of teeth. Similarly, each group of short teeth 254 includes the same number of teeth but may include a different number of teeth. In the embodiment of FIG. 17 there are five teeth in each group of long teeth 252, and there are four teeth in each group of short teeth 254.

The one or more teeth or prongs 252 and 254 are used for engaging and securing conduits 10, 12, or 14 with varying outer diameters within the conduit receiving port 206 when installed. Here, the conduit gripping member 236 includes one or more teeth 252 having a length in a range of between about 0.100 inches and about 0.375 inches, and one or more teeth 254 having a length in a range of between about 0.050 inches and about 0.250 inches. As shown, the teeth 252 are longer than teeth 254. A free end of each tooth or prong 252 and 254 may have a flat end or tip, a single pointed end or tip, or a multi-pointed end or tip. The teeth or prongs 252 and 254 extend inwardly toward the hollow central portion and downwardly or at an angle relative to the ring member 250 from an inner periphery of the ring member 250 as shown in FIG. 7. The downward angle of the teeth 252 and 254 from the inner periphery of the ring 250 may be in the range of about 10 degrees and about 70 degrees. Preferably, the angle is about 30 degrees. The teeth or prongs 252 and 254 may be configured to have different lengths and/or different shapes and configurations suitable to grip and hold a conduit 10, 12 or 14 or conduit 54, 56 or 58 within the conduit receiving port 206.

Continuing to refer to FIGS. 5 and 7, the pressure ring 232 is a hollow circular member that may include one or more ribs 234 extending vertically along its outer surface 235. Each rib 234 corresponds to and engages a notch 324 provided in the assembly receiving area 320, seen in FIG. 4, of the retention assembly opening 207 of the conduit receiving port 206 to secure by friction fit the pressure ring 232 to the circular wall 309 of the conduit receiving port 206. Adhesives or mechanical fasteners may also be used to secure the pressure ring 232 to the circular wall 309 of the conduit receiving port 206. Having each of the one or more ribs 234 positioned within a respective notch 324 also prevents the pressure ring 232 from rotating when the release member 208 is rotated. The pressure ring 232 also includes one or more rails 233 extending from an inner surface thereof toward the center opening of the pressure ring 232. The one or more rails 233 slide along a respective track 356 in the release member 208 as described below. Non-limiting examples of a rail include detents formed or mechanically attached to the pressure ring 232, or pins extending from the pressure ring 232.

Continuing to refer to FIGS. 5 and 7, the release member 208 is a hollow, circular member having an upper portion 357 and a lower portion 358. The opening 359 in the release member 208 has a diameter sufficient to permit the smaller size and the larger size conduits 10, 12, or 14 to pass therethrough. The upper portion 357 has an outer diameter that is greater than the inner diameter of the pressure ring 232. An inner surface 362 of the upper portion 357 of release member 208 may be threaded to receive a threaded surface 364 of the cap 214. The cap 214 may include one or more slots 366 allowing a tool (e.g., a screwdriver) to be inserted therein for allowing easy insertion and removal of the cap 214 from the release member 208. The upper portion 357 release member 208 includes an arm 210 extending therefrom and which may include an orifice 212. The lower portion 358 of the release member 208 has an outer diameter configured and dimensioned to fit inside the pressure ring 232 so that the release member 208 is rotatable within the pressure ring 232. An outer surface of the lower portion 358 includes one or more tracks 356 that are configured and dimensioned to receive the one or more rails 233 extending from the pressure ring 232. In an exemplary embodiment, each track 356 may be a diagonal or helical slot. A width of the track 356 is substantially similar and slightly larger than a diameter or width of the rail 233, such that when the lower portion 358 of the release member 208 is positioned within pressure ring 232, the rail 233 is received within the track 356 and movable in the track 356. According to this arrangement, as the release member 208 is rotated in a clockwise or counterclockwise direction with respect to pressure ring 232, the release member 208 also moves in a vertical direction relative to the pressure ring 232. Lower edge 360 of the release member 208 will normally abut a portion of the conduit gripping member 236, e.g., teeth 252 and 254, preventing the conduit gripping member 236 from gripping a conduit 10, 12, or 14. The lower edge 360 of the lower portion 358 may be a substantially flat edge or the lower edge 360 may have a beveled or tapered edge.

To assemble the retention assembly 240 within the assembly receiving area 320 of a conduit retention port 206, the conduit gripping member 236 is placed within the retention assembly opening 207 of the conduit receiving port 206 so that the ring 250 of the conduit gripping member 236 rests on the lip 318, seen in FIG. 4. The ribs 234 in the pressure ring 232 are then aligned with the notches 324 provided in the assembly receiving area 320 of the retention assembly opening 207, and the pressure ring 232 is positioned within the retention assembly opening 207 so that the pressure ring 232 rests on top of the ring 250 of the conduit gripping member 236. As noted, the ribs 234 and notches 324 have a friction fit to secure the pressure ring 232 to the conduit receiving port 206. In the event an adhesive is used to secure the pressure ring 232 to the conduit receiving port 206, the adhesive would be applied to the outer surface of the pressure ring 232 prior to positioning the pressure ring 232 in the conduit receiving port 206. With the pressure ring 232 secured to the conduit receiving port 206, the conduit gripping member 236 is secured in position within the conduit receiving port 206. The lower portion 358 of the release member 208 is then inserted through the opening in the pressure ring 232 so that the rail 233 is positioned in the track 356.

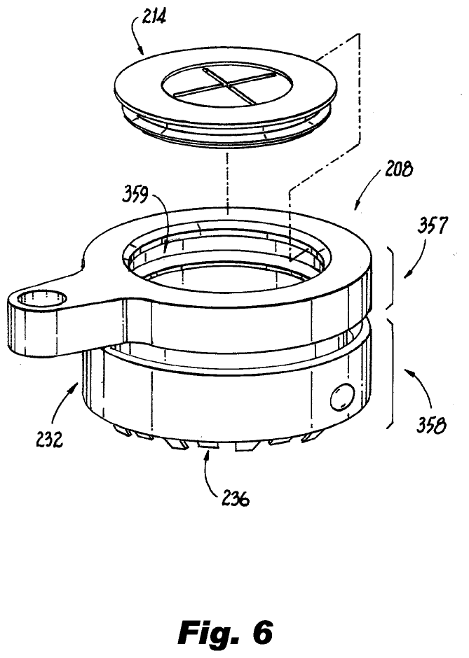

Referring to FIGS. 8 and 9, another exemplary embodiment of a retention assembly according to the present disclosure is shown. The retention assembly 240 is substantially similar to the retention assembly of FIGS. 5-7, except that a seal member 230 is positioned between the upper portion 357 of the release member 208 and the pressure ring 232. The seal member 230 is a circular member having a center opening therethrough. The seal member 230 is preferably formed from any suitable material that is sufficiently flexible, structurally and environmentally durable and resilient. Non-limiting examples of a suitable material for the seal member 230 include silicone, rubber and latex. The seal member 230 has an outer diameter that is substantially the same as or slightly greater than the diameter of the retention assembly opening 207 of the conduit receiving port 206, seen in FIG. 6. The seal member 230 has an inner diameter that is substantially the same as or slightly smaller than the outer diameter of the lower portion 358 of the release member 208. The seal member 230 provides a sealed fit between the pressure ring 232, the release member 208 and the conduit receiving port 206 minimizing and possibly preventing moisture from passing into the device opening 202 of the box 200. If the retention assembly 240 of FIGS. 8 and 9 is used, the process for assembling the retention assembly 240 would be the same as described above, except that the seal member 230 would be positioned between the pressure ring 232 and the upper portion 357 of the release member 208.

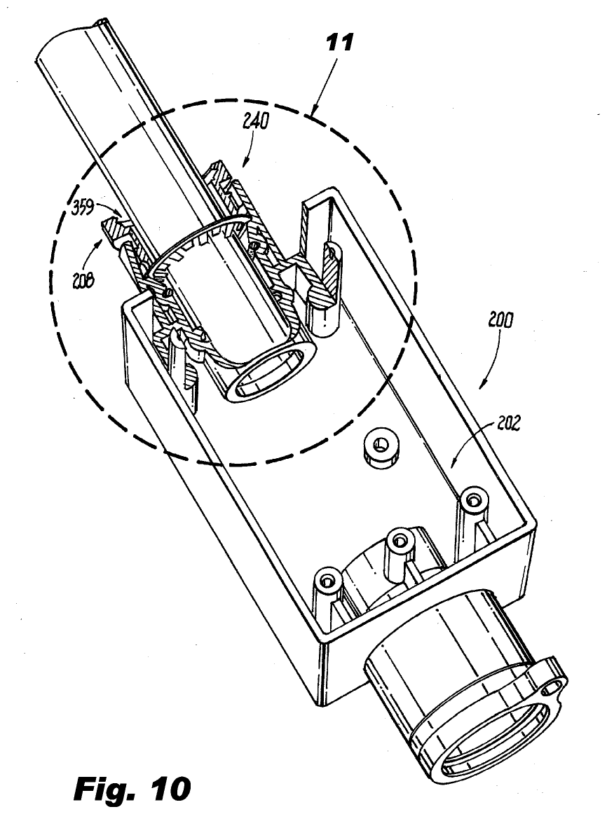

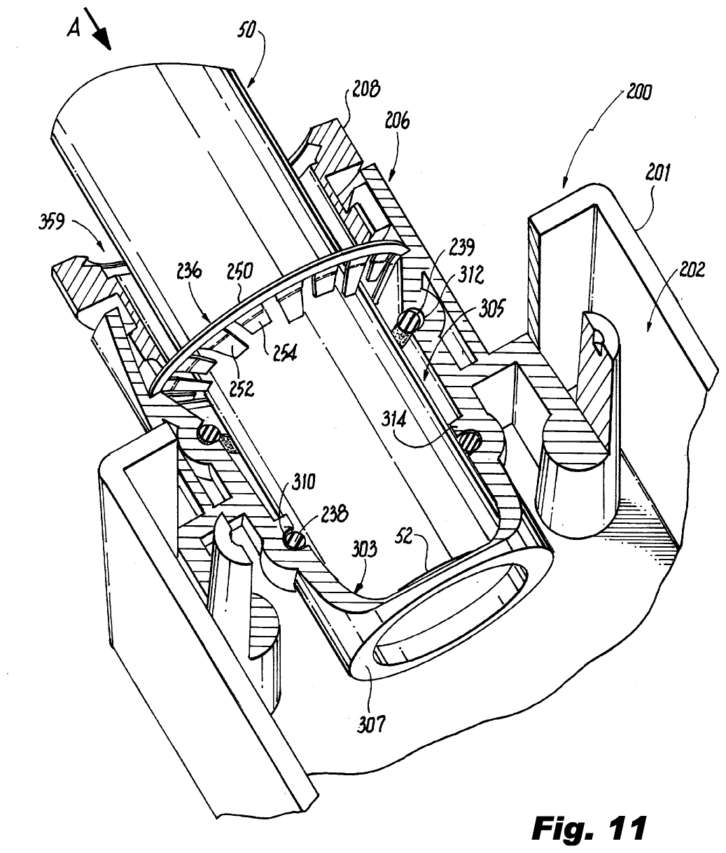

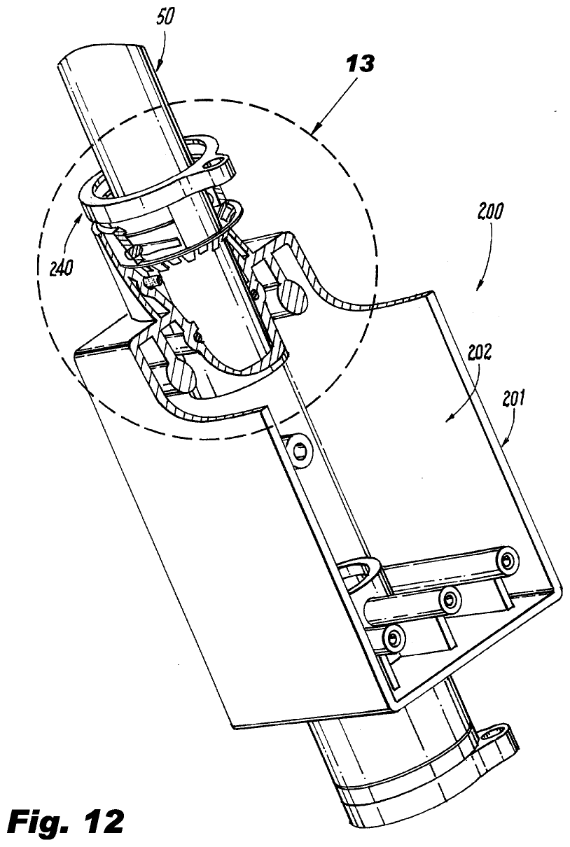

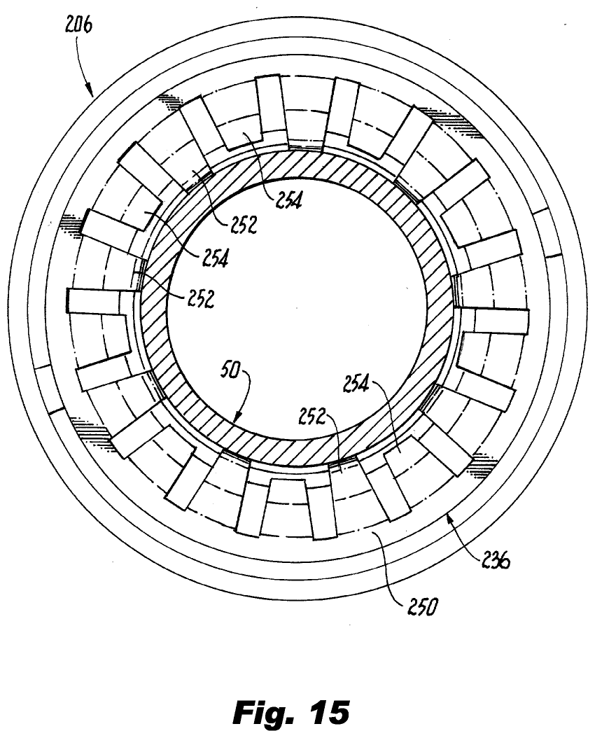

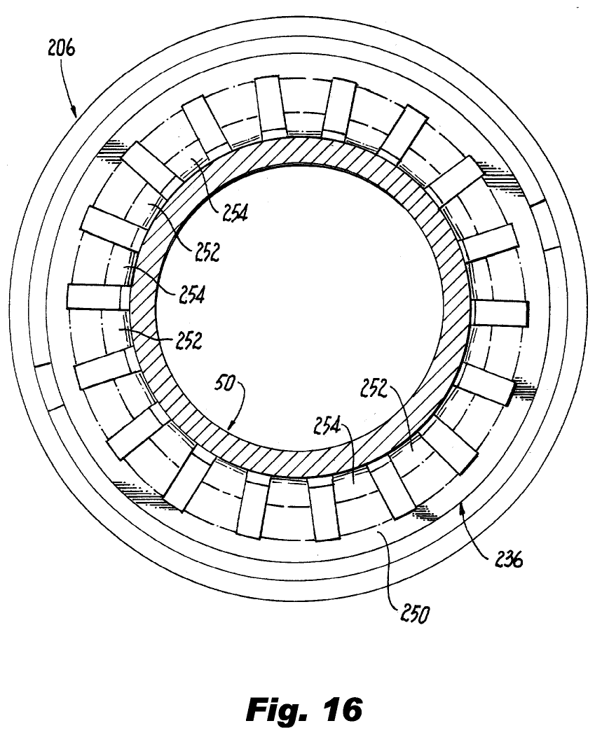

Operation of the retention assembly 240 gripping and releasing a conduit 50 will now be described with reference to FIGS. 10-16. As shown in FIGS. 10 and 11, to secure the conduit 50 to the electrical box 200, the conduit 50 is positioned at the opening 359, of release member 208, seen in FIG. 5, and pressed into the retention assembly 240 in the direction shown by arrow “A” with sufficient force to move the conduit 50 through the retention assembly 240 into the chamber 305, and if the conduit is a smaller size conduit into chamber 303 until the distal end 52 of the conduit 50 contacts the appropriate lip 307 or 314. In the example shown, the conduit 50 is a smaller diameter conduit that enables the conduit to travel into the chamber 303 until the distal end 52 contacts the lip 307. As the conduit 50 passes through the retention assembly 240, the conduit gripping member 236 grips the conduit 50 allowing the conduit to continue to move into the conduit receiving port 206 while preventing the conduit from being removed from the conduit receiving port 206, thus securing the conduit to the box 200. More specifically, in the exemplary embodiment shown, conduit gripping member 236 includes the circular ring 250 and teeth 252 and 254 that face downward relative to the circular ring 250 gripping the conduit 50 and preventing the conduit from being removed or withdrawn from the conduit receiving port 206. Since this exemplary embodiment shows a smaller diameter conduit being installed in the conduit receiving port 206, only the longer teeth 252 grip the conduit 50 as it passes through the conduit receiving member 206 and the retention assembly 240 including the conduit gripping member 236, as seen in FIG. 15. If a larger diameter conduit were installed in the conduit receiving port 206, both the longer teeth 252 and the smaller teeth 254 would grip the conduit 50 as it passes through the conduit receiving port 206 and the retention assembly 240 including the conduit gripping member 236, as seen in FIG. 16. It is noted that as the teeth 252 and 254 grip the conduit 50, the teeth 252 and 254 may flex as the conduit is being passed through the conduit receiving port 206 and the retention assembly 240 including the conduit gripping member 236. As the smaller diameter conduit 50 passes through the chamber 303, the seal member 238 positioned in groove 310 of the conduit receiving port 206 contacts the outer surface of the conduit 50 creating a seal to minimize and possibly prevent moisture from passing into the device opening 202 of the box 200. It is noted that if the conduit 50 inserted into the conduit receiving port 206 were a larger size conduit, the as the larger diameter conduit 50 passes through the chamber 305, the seal member 239 positioned in groove 312 would contact the outer surface of the conduit 50 creating a seal to minimize and possibly prevent moisture from passing into the device opening 202 of the box 200. As described above, the retention assembly 240 may be capable of receiving various outer diameter conduits 50, similar to conduits 10, 12 and/or 14, shown in FIG. 1. As a non-limiting example, the conduit 10 may be a ¾ inch conduit, the conduit 12 may be a ½ inch conduit, and the conduit 14 may be a 1 inch conduit.

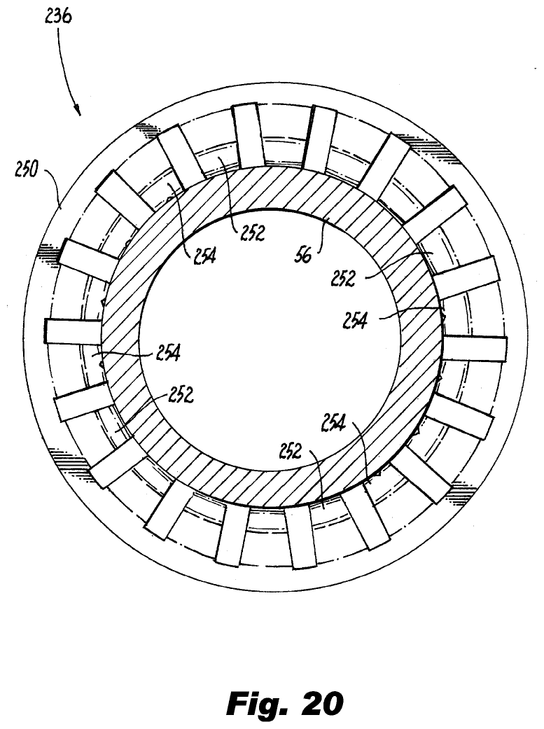

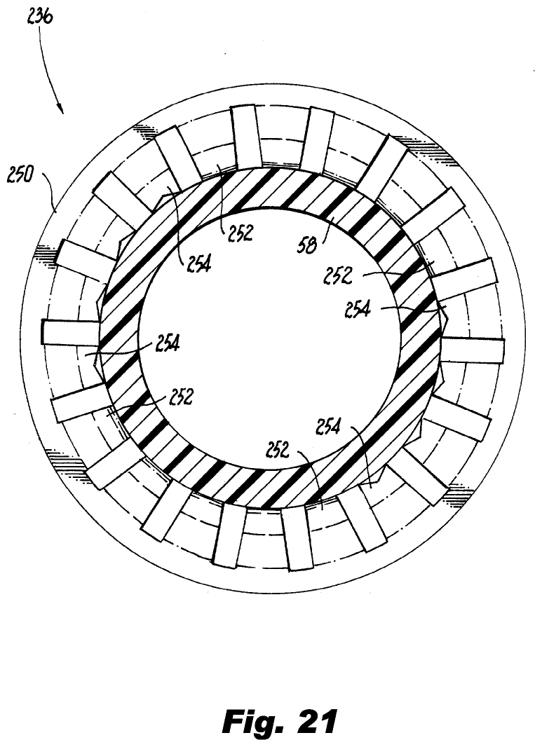

As described above, in other embodiments the retention assembly 240 may be capable of receiving conduits that are different conduit types of the same size. As non-limiting examples, the retention assembly 240 may be capable of receiving EMT type conduits of a certain size and Rigid type conduits of the same certain size and PVC type conduits of the same certain size. As a specific illustration, the retention assembly 240 may be capable of receiving a ¾ inch EMT conduit 54, seen in FIG. 19, and a ¾ inch Rigid conduit 56, seen in FIG. 20, and a ¾ PVC conduit 58, seen in FIG. 21.

In the embodiment of FIGS. 17 and 18, the retention assembly 240 is substantially similar to the retention assembly 240 described above, except that the conduit gripping member 236 includes a circular ring 250 with a hollow central portion and two groups of long teeth 252 (Group A and Group B) and two groups of short teeth 254 (Group C and Group D). The groups are alternately positioned around the circular ring 250, as shown in FIG. 17. In the exemplary embodiment shown, each group of long teeth 252 includes the same number of teeth, and each group of short teeth 254 includes the same number of teeth. More specifically, in the embodiment shown, each group (Group A and Group B) of long teeth 252 include five teeth, and each group (Group C and Group D) of short teeth 254 include four teeth. However, each group (Group A and Group B) may include a different number of teeth where, for example, Group A has five teeth and Group B has six teeth, and each group (Group C and Group D) may include a different number of teeth where, for example, Group C has three teeth and Group D has four teeth.

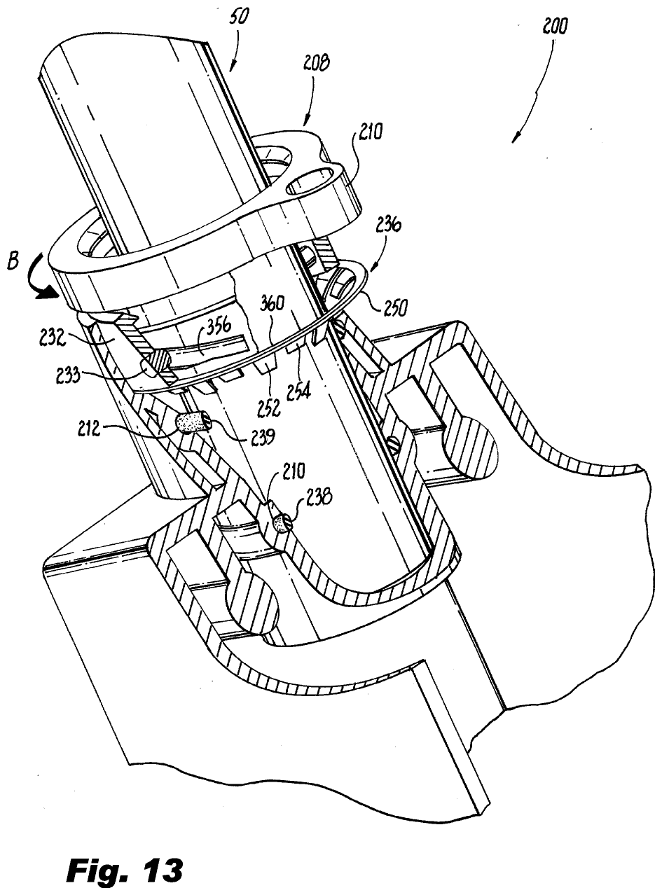

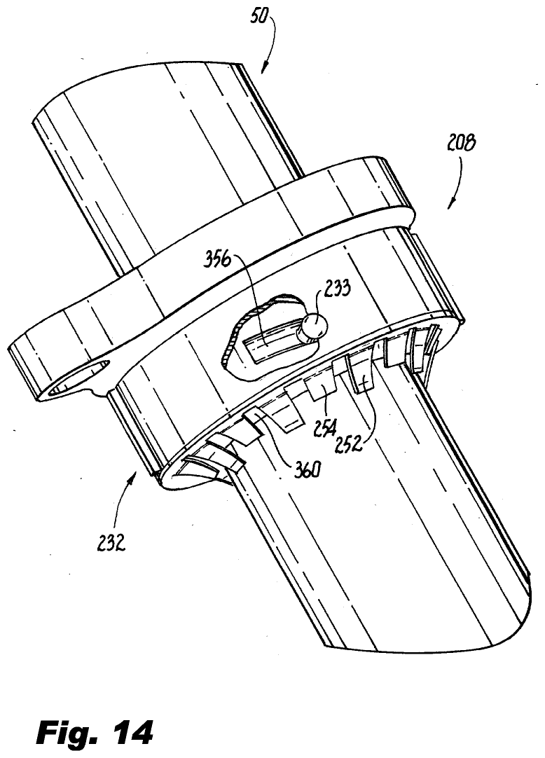

To release the conduit 50 from the conduit receiving port 206, the release member 208 is rotated in a counterclockwise direction, as shown by arrow B in FIG. 13, causing the rail 233 extending from the pressure ring 232 to move along the track 356 in the lower portion 358 of the release member 208. As noted above, with the track 356 being oriented diagonally or helically, as the rail 233 rides along the track 356 the release member 208 also moves in the direction of the conduit gripping member 236 such that the lower edge 360 of release member 208 abutting the teeth 252 and 254 of the conduit gripping member 236 presses the teeth 252 and 254 in a direction away from the conduit 50 and moves between the free end of the teeth 252 and 254 and the conduit 50, thus releasing the conduit gripping member's 236 grip on the conduit 50 and freeing the conduit 50 for removal from the conduit receiving port 206, as seen in FIG. 14.

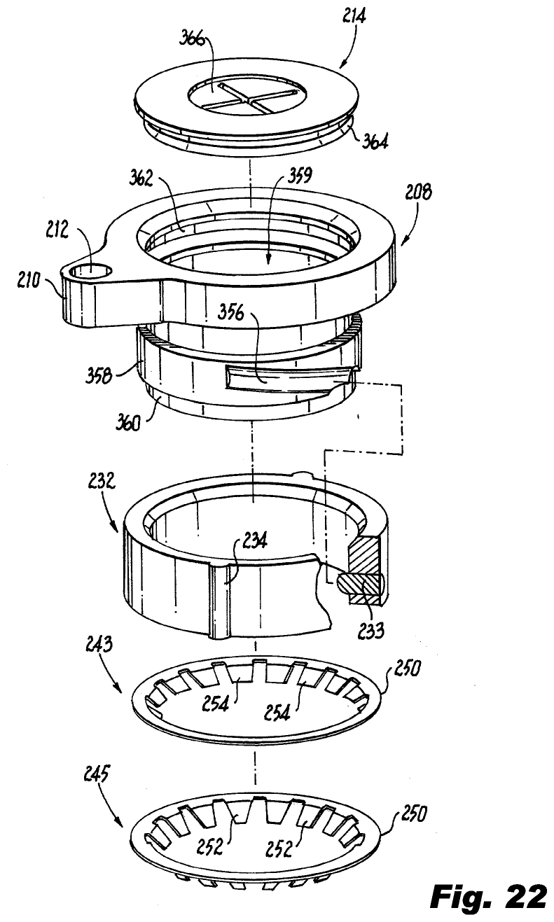

Referring to FIG. 22-24, another exemplary embodiment of the retention assembly 240 according to the present disclosure is shown. In this exemplary embodiment, the retention assembly 240 includes a release member 208, a pressure ring 232 and two conduit gripping members 243 and 245. The retention assembly 240 in this exemplary embodiment may also include a removable cap 214, and a second sealing member 230, seen in FIGS. 8 and 9. The release member 208, a pressure ring 232, removable cap 214 and the second sealing member 230 were described hereinabove and for ease of description are not repeated. In this exemplary embodiment, a first conduit gripping member 243 includes a circular ring member 250 with a hollow central portion. The hollow central portion is configured and dimensioned to receive the desired smaller and larger diameter conduits of different sizes 10, 12 or 14, seen in FIG. 1, or the smaller and larger diameter of the same size conduit made of different materials 54, 56 and 58, seen in FIGS. 19-21. The conduit gripping member 243 is formed from a rigid material, such as steel. Preferably, the conduit gripping member 243 is formed from spring steel such as, for example, 1050 annealed spring steel that may be zinc plated. In this exemplary embodiment, the conduit gripping member 243 is a spring-like structure that includes one or more teeth or prongs 254 of a first length extending from the ring member 250 toward the hollow central portion and angled relative to the ring member. The downward angle of the teeth 254 from the inner periphery of the ring member 250 may be in the range of about 10 degrees and about 70 degrees. Preferably, the angle is about 30 degrees. The first length may be in a range of between about 0.050 inches and about 0.250 inches. A free end of each tooth or prong 254 may have a flat end or tip, a single pointed end or tip, or a multi-pointed end or tip. In this exemplary embodiment, the conduit gripping member 245 is a spring-like structure that includes one or more teeth or prongs 252 of a second length extending from the ring member 250 toward the hollow central portion and angled relative to the ring member. The downward angle of the teeth 252 from the inner periphery of the ring member 250 may be in the range of about 10 degrees and about 70 degrees. Preferably, the angle is about 30 degrees. The second length may be in a range of about 0.100 inches and about 0.375 inches. A free end of each tooth or prong 252 may have a flat end or tip, a single pointed end or tip, or a multi-pointed end or tip. As shown, the teeth 252 are longer than teeth 254, but the teeth 252 may be shorter than the teeth 254.

To assemble the retention assembly 240 of this embodiment within the assembly receiving area 320 of a conduit retention port 206, the conduit gripping member 245 is positioned within the retention assembly opening 207 of the conduit receiving port 206 so that the ring 250 of the conduit gripping member 236 rests on the lip 318. The conduit gripping member 243 is then positioned within the retention assembly opening 207 on top of the conduit gripping member 245. The ribs 234 in the pressure ring 232 are then aligned with the notches 324 provided in the assembly receiving area 320 of the retention assembly opening 207, seen in FIG. 4, and the pressure ring 232 is positioned within the retention assembly opening 207 so that the pressure ring 232 rests on top of the ring 250 of the conduit gripping member 243. As noted, the ribs 234 and notches 324 have a friction fit to secure the pressure ring 232 to the conduit receiving port 206. In the event an adhesive is used to secure the pressure ring 232 to the conduit receiving port 206, the adhesive would be applied to the outer surface of the pressure ring 232 prior to positioning the pressure ring 232 in the conduit receiving port 206. With the pressure ring 232 secured to the conduit receiving port 206, the conduit gripping members 243 and 245 are secured in position within the conduit receiving port 206. The lower portion 358 of the release member 208 is then inserted through the opening in the pressure ring 232 so that the rail 233 is positioned in the track 356.

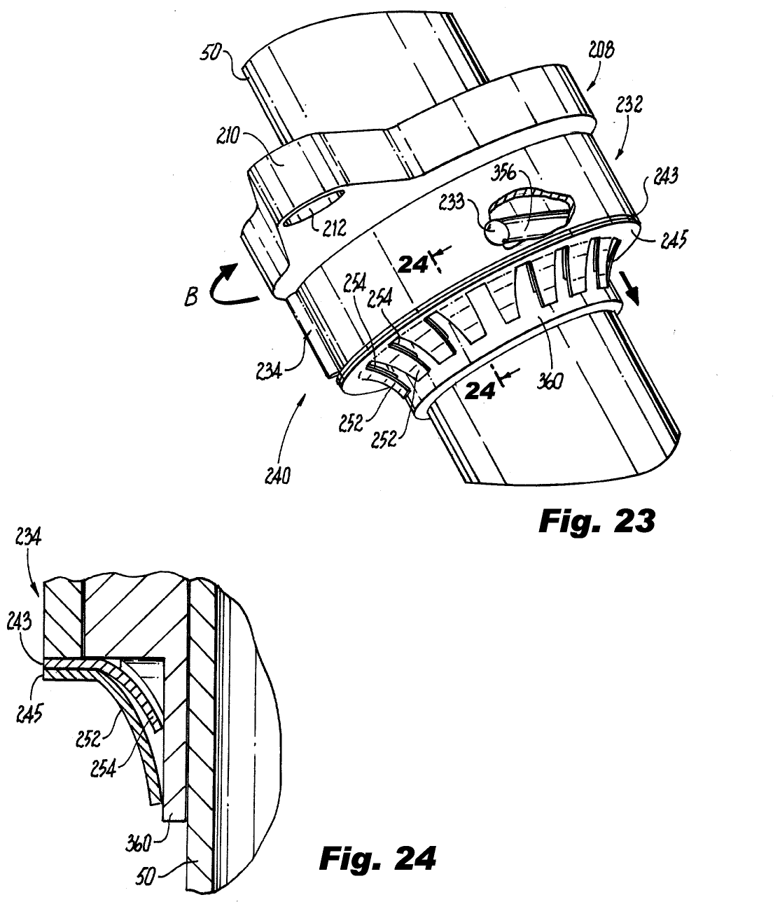

Operation of the retention assembly 240 gripping a conduit, e.g., conduit 50, is substantially similar to that described above with reference to FIGS. 10-16, except using the retention assembly 240 of FIG. 22, the two conduit gripping members 243 and 245 are used to grip the conduit. Operation of the retention assembly 240 releasing a conduit, e.g., conduit 50, is substantially similar to that described above with reference to FIGS. 10-16, except using the retention assembly 240 of FIG. 22, the grip of teeth 252 and/or 254 has to be released from the conduit 50. To release the conduit, e.g., conduit 50, from the conduit receiving port 206, the release member 208 is rotated in a counterclockwise direction, as shown by arrow B in FIG. 23, causing the rail 233 extending from the pressure ring 232 to move along the track 356 in the lower portion 358 of the release member 208. As noted above, with the track 356 being oriented diagonally or helically, as the rail 233 rides along the track 356 the release member 208 also moves in the direction of the conduit gripping members 243 and 245 such that the lower edge 360 of release member 208 abutting the teeth 252 and/or 254 of the conduit gripping members 243 and 245 presses the teeth 252 and/or 254 in a direction away from the conduit 50 and moves between the free end of the teeth 252 and/or 254 and the conduit 50, as seen in FIG. 24. As a result, the grip of the conduit gripping members 243 and/or 245 on the conduit 50 is released freeing the conduit 50 for removal from the conduit receiving port 206, as seen in FIGS. 23 and 24.

One or more of the exemplary embodiments of the present disclosure describe a weatherproof box with hubs or so called conduit receiving ports that have a push-to-connect style fitting built directly into the hubs. For an installation process using such devices, the user will simply push in the conduit, such as PVC, EMT or Rigid conduit, into the hub and a metal retainer ring will bite into the conduit locking it into the hub. According to the exemplary embodiments of the present disclosure, one or more members forming an integral conduit release member are built into the hubs. According to various embodiments, an O-ring or other gaskets may be incorporated in the hub to minimize and possibly prevent moisture from getting into the interior of the box. In alternative embodiments, multiple options are provided that make available different weatherproof box configurations, each having a different hub quantity and/or hub location around the box, wherein the hub concept or construction can be selected from the examples described herein. In certain embodiments, a portion of the topmost piece of the hub or another internal component of the fitting may be threaded to accept a closure plug when the hub is not in use. These new methods, configurations and fittings reduce the need for a traditional separate conduit fitting and will drastically reduce the labor required to install the conduit to the box and allows easy removal of conduits from the hub without requiring any additional tools.

In certain embodiments, the box housing is constructed of steel or cast aluminum. In yet other embodiments, one of many different plastics (PVC, PC) that are traditionally used may be selected or any other traditionally used material for electrical boxes, including weatherproof electrical boxes. Weatherproof fittings such as O-rings or other gaskets are constructed of Ethylene Propylene diene Monomer (EPDM), another rubber, silicon or any other suitable material for providing an appropriate seal. The alternative mechanisms described herein may share certain features and/or capabilities, but the manufacturing assembly process may vary.

In certain exemplary embodiments, a permanently fixed fitting will be used having an integrated conduit gripping member such as a spring steel ring with teeth and a conduit release member. For such embodiments, a separate tool is not necessary to remove conduits from the box after installation. For example, according to certain exemplary embodiments, the conduit release member is provided integrally in conjunction with the conduit gripping member. The release is moved in a specific direction which causes deflection of the conduit gripping member allowing easy removal of the conduit from the hub. For example, when the conduit release member is moved in a specific direction, the teeth of the conduit gripping device are moved away from the conduit, thus releasing the conduit and allowing the conduit to be easily removed from the box. In yet another illustrative embodiment, the integral fitting and release are removable from the hub structure that is integrated into the box housing thereby allowing replacement of internal fitting components such as a retention assembly. According to yet other exemplary embodiments, a conduit receiving port including integral conduit retention device is formed as a unit capable of being attached to an electrical box in any suitable manner.

While illustrative embodiments of the present disclosure have been described and illustrated above, it should be understood that these are exemplary and are not to be considered as limiting. Additions, deletions, substitutions, and other modifications can be made without departing from the spirit or scope of the present disclosure. Accordingly, the present disclosure is not to be considered as limited by the foregoing description.

What is claimed is:

1. An electrical box comprising:
at least one conduit receiving port having an inner surface and a retention assembly opening; and
at least one conduit retention assembly positioned in the retention assembly opening, the at least one conduit retention assembly including:
at least one conduit gripping member;
a pressure ring positioned adjacent the at least one conduit gripping member;
a conduit release member operatively coupled to the pressure ring and movable relative to the pressure ring.

2. The electrical box according to claim 1, further comprising a removable cap operatively coupled to the conduit release member.

3. The electrical box according to claim 1, wherein the at least one gripping member includes a ring having a hollow central portion, and a plurality of teeth of varying lengths extending from the ring toward the hollow central portion.

4. The electrical box according to claim 1, wherein the plurality of teeth of varying lengths include a plurality of teeth having a first length and a plurality of teeth having a second length, wherein the first length is shorter than the second length, and wherein the plurality of first length teeth and the plurality of second length teeth are arrange around the ring in an alternating pattern.

5. The electrical box according to claim 1, wherein the plurality of teeth of varying lengths include a plurality of teeth having a first length and a plurality of teeth having a second length, wherein the first length is shorter than the second length, wherein the plurality of first length teeth are arrange around the ring in at least one first length group, and wherein the plurality of second length teeth are arrange around the ring in at least one second length group.

6. The electrical box according to claim 1, wherein the plurality of teeth extend at an angle relative to the ring.

7. The electrical box according to claim 1, wherein the at least one conduit gripping member includes a first conduit gripping member and a second conduit gripping member, wherein the first conduit gripping member includes a first ring having a hollow central portion, and a plurality of teeth of a first length extending from the first ring toward the hollow central portion, and wherein the second conduit gripping member includes a second ring having a hollow central portion, and a plurality of teeth of a second length extending from the second ring toward the hollow central portion.

8. The electrical box according to claim 1, wherein the first length is shorter than the second length.

9. The electrical box according to claim 1, wherein the pressure ring includes a circular body having at least one rib extending along an outer surface of the body.

10. The electrical box according to claim 9, wherein the at least one rib engages a notch in the inner surface of the at least one conduit receiving port.

11. The electrical box according to claim 1, wherein the pressure ring includes at least one rail extending from an inner surface of the pressure ring toward a center opening of the pressure ring.

12. The electrical box according to claim 11, wherein the at least one rail is positioned within a track in the conduit release member such that the at least one rail slides along the track in the conduit release member when the conduit release member is moved relative to the pressure ring.

13. An electrical box comprising:
at least one conduit receiving port having an inner surface and a retention assembly opening; and
at least one conduit retention assembly secured within the retention assembly opening, the at least one conduit retention assembly including:
at least one conduit gripping member that includes a ring having a hollow central portion and a plurality of teeth of varying lengths extending from the ring toward the hollow central portion;
a pressure ring positioned adjacent the at least one conduit gripping member; and
a conduit release member operatively coupled to the pressure ring and movable relative to the pressure ring.

14. The electrical box according to claim 13, further comprising a removable cap operatively coupled to the conduit release member.

15. The electrical box according to claim 13, wherein the plurality of teeth of varying lengths include a plurality of teeth having a first length and a plurality of teeth having a second length, wherein the first length is shorter than the second length, and wherein the plurality of first length teeth and the plurality of second length teeth are arrange around the ring in an alternating pattern.

16. The electrical box according to claim 13, wherein the plurality of teeth of varying lengths include a plurality of teeth having a first length and a plurality of teeth having a second length, wherein the first length is shorter than the second length, wherein the plurality of first length teeth are arrange around the ring in at least one first length group, and wherein the plurality of second length teeth are arrange around the ring in at least one second length group.

17. The electrical box according to claim 13, wherein the plurality of teeth extend at an angle relative to the ring.

18. The electrical box according to claim 13, wherein the pressure ring includes a circular body having at least one rib extending along an outer surface of the body.

19. The electrical box according to claim 18, wherein the at least one rib engages a notch in the inner surface of the at least one conduit receiving port.

20. The electrical box according to claim 13, wherein the pressure ring includes at least one rail extending from an inner surface of the pressure ring toward a center opening of the pressure ring.

21. The electrical box according to claim 20, wherein the at least one rail is positioned within a track in the conduit release member such that the at least one rail slides along the track in the conduit release member when the conduit release member is moved relative to the pressure ring.

22. A conduit retention assembly comprising:
at least one conduit gripping member includes a ring having a hollow central portion and a plurality of teeth of varying length extending from the ring toward the hollow central portion such that each of the plurality of teeth are at an angle relative to the ring;
a pressure ring positioned adjacent the at least one conduit gripping member; and
a conduit release member operatively coupled to the pressure ring and movable relative to the pressure ring.

23. The electrical box according to claim 22, wherein the plurality of teeth of varying lengths include a plurality of teeth having a first length and a plurality of teeth having a second length, wherein the first length is shorter than the second length, and wherein the plurality of first length teeth and the plurality of second length teeth are arrange around the ring in an alternating pattern.

24. The electrical box according to claim 22, wherein the plurality of teeth of varying lengths include a plurality of teeth having a first length and a plurality of teeth having a second length, wherein the first length is shorter than the second length, wherein the plurality of first length teeth are arrange around the ring in at least one first length group, and wherein the plurality of second length teeth are arrange around the ring in at least one second length group.

25. The conduit retention assembly according to claim 22, wherein the pressure ring includes at least one rib extending along an outer surface of the pressure ring configured to engage a notch in a conduit receiving port of an electrical box.

26. The electrical box according to claim 22, wherein the pressure ring includes at least one rail extending from an inner surface of the pressure ring toward a center opening of the pressure ring.

27. The electrical box according to claim 26, wherein the at least one rail is positioned within a track in the conduit release member such that the at least one rail slides along the track in the conduit release member when the conduit release member is moved relative to the pressure ring.
